(19) United States
(12) Patent Application Publication
(10) Pub. No.: US 2017/0013064 A1
(43) Pub. Date: Jan. 12, 2017

(54) AUTOMATED OPC CONNECTIVITY

(71) Applicant: BOS SOLUTIONS, Houston, TX (US)

(72) Inventor: Kason Drake Knight, Tomball, TX (US)

(73) Assignee: BOS SOLUTIONS, Houston, TX (US)

(21) Appl. No.: 14/796,484

(22) Filed: Jul. 10, 2015

(51) Int. Cl. H04L 29/08; G06F 17/24; H04L 12/24; G06F 17/30

(52) U.S. Cl. CPC H04L 67/14; G06F 17/30312; G06F 17/248; H04L 41/12; H04L 41/082

(57) ABSTRACT

The invention relates to an information data system (IDS) configured to automatically identify, connect to, monitor, and receive information from machines or devices located within a desired network or proximity through a wireless connection. The IDS may include a computer having at least one user interface, at least one software module, a networking module, at least one wired or wireless networking device, and at least one client device, wherein each of the at least one client devices are in communication with and controlled by the computer. The at least one software module includes instructions that are read by the computer and cause the integrated data system to automatically identify and automatically connect to at least one machine using the at least one wired or wireless networking devices.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The present application relates to the field of integrated data acquisition and remote monitoring. More specifically, the application relates to an Integrated Data System (IDS) configured to receive inputs from and monitor remote machines and processes.

2. Description of the Prior Art

Machine monitoring is essential in numerous industries ranging from shipping and aerospace to HVAC and power generation. Industries worldwide rely on technology to assist in data acquisition, machine monitoring, and diagnostics. Control devices have allowed the user the ability to identify and read a multitude of parameters related to the operating conditions of specific machines. With the integration of a human-machine interface, the user is able to read real-time data and has the ability to interact with the machine.

Object linking and embedding for Process Control (OPC) is a standards specification created to communicate data between devices from different manufacturers. The interface is written once and then has the ability to be reused by any business, supervisory control and data acquisition (SCADA), human machine interface (HMI), or custom software package. An OPC Server accesses data from a control device and translates the data to the OPC Client.

Currently, most control device and condition monitoring applications, including OPC Servers, operate within a stationary framework. In the current stationary framework, a user is required to manually identify and manually input each machine's specific driver and communication settings into the control device translation software.

### SUMMARY OF THE INVENTION

Most control device and condition monitoring applications, including OPC Servers, operate within a stationary framework. In the existing stationary framework, each monitored machine is not readily removed from the operating location. Additionally in the current stationary framework, a user is required to manually identify and manually input each machine's specific driver and communication settings into the control device translation software. In some industries and applications, however, machines are rotated and swapped from location frequently and thus require users to repeatedly enter manually the new machine's configuration information.

U.S. Pat. No. 6,526,566 B1 discloses a system for creating a graphical program which accesses data from/to one or more of a data source or a data target. While the '566 patent simplifies the task of creating or configuring a graphical program to exchange data with a data source and/or data target, a user must create or configure the graphical program and manually connect various nodes or icons together. If the user desires the graphical program to access data from/to one or more of a data source or a data target, the user must manually cause to be displayed a data access node in the graphical program and must then configure the data access node with location information of one or more of a data source or a data target. The '566 patent does not disclose an integrated data system (IDS) that automatically scans a network to identify all programmable logic controllers having a unique network device identifier, automatically modifies the OPC server configuration, and then connects to the identified programmable logic controllers.

U.S. Pat. No. 6,728,262 B1 teaches a method for integrating the management of process control and network operation into one software platform. The '262 patent also teaches the simultaneous management of process control data and network diagnostic data transmitted over an open architecture network, which retrieves network condition information and then converts the diagnostic information into a useable process control format. However, the '262 patent fails to disclose an IDS that automatically scans a network to identify all programmable logic controllers having a unique network device identifier, automatically modifies the OPC server configuration, and then connects to the identified programmable logic controllers.

U.S. Pat. No. 8,028,046 B2 discloses a method for determining network device information at a network device using a boot strapping protocol during an initial set-up process of the network device. The '046 method includes modifying a configuration profile of the network device to connect to a network in a first device mode using the network device information. The '046 patent does not disclose an IDS that automatically scans a network to identify all programmable logic controllers having a unique network device identifier, automatically modifies the OPC server configuration, and then connects to the identified programmable logic controllers.

A need therefore exists for an IDS that automatically scans a network to identify all programmable logic controllers having a unique network device identifier, automatically modifies the OPC server configuration, and connects to the identified programmable logic controllers within specified proximity.

Illustrative embodiments of the present invention, shown in the drawings, are more fully described in the Detailed Description section of this disclosure. It is to be understood that there is no intention to limit the invention to the forms described in this Summary of the Invention or in the Detailed Description section of this disclosure. One skilled in the art can recognize that there are numerous modifications, equivalents, and alternative constructions that fall within the spirit and scope of the invention as expressed in the claims.

In at least one embodiment, the integrated data system may include a computer having at least one user interface, at least one software module, a networking module, at least one wired or wireless networking device, and at least one client device. In such embodiments, each of the at least one client devices are in communication with and controlled by the computer. Further, the at least one software module includes instructions that are read by the computer and cause the integrated data system to automatically identify and automatically connect to at least one machine using the at least one wired or wireless networking devices.

It is also contemplated that an additional embodiment includes a method for automatically connecting an integrated data system with at least one remote machine, wherein the method includes scanning a network remote machine subnet, wherein the remote machine subnet has at least one remote machine, generating a first list of unique network identifiers, and programmatically converting the first list of unique network identifiers into a second list, wherein the second list has at least one machine type and at least one asset number. Further, It is also contemplated that such embodiments may include, modifying at least one object linking and embedding for process control server configuration template to form at least one modified object linking and embedding for process control server configuration template, wherein the modified object linking and embedding for process control server configuration template is compatible with the second list, and wherein the at least one object linking and embedding for process control server configuration template is stored within at least one integrated data system. Further, It is also contemplated that such embodiments may include, updating at least one object linking and embedding for process control server runtime with the modified object linking and embedding for process control server configuration template to form at least one updated configuration template, establishing a connection automatically between the integrated data system and restarting the at least one integrated data system to automatically establish a connection with the at least one remote machine. In such embodiments, the remote machine subnet comprises at least one remote machine; the modified configuration template matches the second list; and the at least one object linking and embedding for process control server configuration template is stored within at least one integrated data system.

In yet an additional embodiment, the present disclosure contemplates a non-transitory computer readable medium having stored thereon, at least one software module, wherein the at least one software module has at least one code section that is executable by an integrated data system to perform a method, wherein the method includes, scanning at least one remote machine subnet, wherein the at least one remote machine subnet comprises at least one remote machine, generating a first list comprising a plurality of unique network identifiers, programmatically converting the first list into a second list, wherein the second list comprises a plurality of machine types and asset numbers, modifying at least one object linking and embedding for process control server configuration template to be compatible with the second list, wherein the at least one object linking and embedding for process control server configuration template is stored within an integrated data system, updating the object linking and embedding for process control server configuration template to create an updated configuration template, and restarting the object linking and embedding for process control server configuration template to automatically establish a connection with the at least one remote machine based on the updated configuration template.

### BRIEF DESCRIPTION OF THE DRAWINGS

FIG. 1 illustrates a multiple machine remote monitoring network.

FIG. 2 illustrates an exemplary network device identifier scheme.

FIG. 3 illustrates a flow chart for automatically connecting a machine to an OPC server.

FIG. 4 illustrates an exemplary list of network device identifiers found on a local network.

FIG. 5 illustrates an exemplary list of machine types and asset numbers that have been converted based on a predefined network device identifier scheme or reference to a relational database.

FIG. 6A illustrates a predefined OPC server configuration template.

FIG. 6B illustrates an automatically updated OPC server template.

### DETAILED DESCRIPTION OF THE PREFERRED EMBODIMENT

The present application seeks to provide a solution to the aforementioned problems by providing a method for automatically scanning, detecting, identifying, connecting to, monitoring, sending and receiving information from remote machines or devices having one or more unique identifiers thereon and located within a desired predetermined network and/or proximity from the integrated data system.

In at least one embodiment, the integrated data system comprises: a computer or other computing device having at least one user interface; at least one software module; a networking module; at least one wired or wireless networking device; and at least one client device, wherein the at least one client device may be used to remotely access and view data on the computer or other computing device. In at least one embodiment, the integrated data system automatically scans, detects, and/or identifies one or more remote machines or devices having one or more unique network identifiers thereon. In some embodiments, the integrated data system automatically identifies each of the unique network identifiers on at least one programmable logic controller.

As used herein, the term “remote” may be used to describe a machine or other device which may be physically near or far from another machine or target device, but wherein the IDS is a separate entity and not integrated into the machine or target device itself.

In some embodiments, the at least one client device may remotely access the computer via an open database connectivity (ODBC), a remote desktop protocol (RDP), and/or hypertext transfer protocol (HTTP). In some embodiments, the at least one client device may be a laptop, a mobile phone, a tablet, or some other electronic device that is capable of remotely accessing and viewing data. In such embodiments, each of the client devices may be in communication with and controlled by the computer. Further, the at least one software module may include instructions that are read by the computer and cause the integrated data system to automatically identify and automatically connect to at least one machine using at least one client device and at least one of the wired or wireless networking devices.

It is also contemplated that an additional embodiment includes a method for automatically connecting an integrated data system with at least one remote machine or target device comprising: scanning a network subnet to identify the presence of any remote machines or other devices; generating a list of unique network device identifiers found while scanning the network subnet; programmatically converting the list of network device identifiers into a list of at least one machine type and at least one asset number based on a predefined scheme or reference to a relational database; modifying at least one object linking and embedding for process control server configuration template stored within at least one integrated data system, to match the list of machine types and asset numbers; updating the at least one object linking and embedding for process control server runtime with the modified process control server configuration template to form at least one updated configuration template, wherein the updated configuration template is based on a unique network identifier of a remote machine or target device; and restarting the at least one object linking and embedding for process control server to automatically establish a connection with a remote machine based on the updated configuration template. In some embodiments, the server configuration template is implemented by the object linking and embedding for process control server.

In yet an additional embodiment, the present disclosure contemplates a non-transitory computer readable medium having stored thereon at least one software module, wherein the at least one software module has at least one code section that is executable by an integrated data system to perform a method, wherein the method comprises: scanning at least one network subnet to identify the presence of any remote machines or other devices, wherein the at least one network subnet comprises at least one remote machine; generating a first list comprising a plurality of unique network device identifiers based on the identified remote machines or other devices; programmatically converting the first list into a second list comprising a plurality of machine types and asset numbers based on a predefined scheme or based on reference to a relational database; modifying an object linking and embedding for process control server configuration template to match the second list, wherein the object linking and embedding for process control server configuration template is stored within the integrated data system; updating the object linking and embedding for process control server configuration template to create an updated configuration template; and restarting the object linking and embedding for process control server configuration template to automatically establish a connection with the at least one remote machine based on the updated configuration template. In some embodiments, the server configuration template is implemented by the object linking and embedding for process control server.

As used herein, the term “automatic” may be defined as the execution of a logical process or event without dependency on an external source to initiate or control the process or event. In various embodiments, the term “automatic” may describe the ability of a computer or other computing device to independently determine and configure data connection parameters by applying situation specific input variables to a predefined logic procedure. This process may eliminate the requirement of a skilled worker to manually perform repetitive tasks. Other common examples of automatic processes may include the operation of traffic lights, thermostat temperature control, and automotive anti-lock braking systems.

As used herein, the term “machine” may be defined as a mechanical and/or electrical apparatus engineered to perform one or more particular task(s). In various embodiments, the term “machines” may be used to refer to industrial equipment that contain rotating and/or reciprocating components controlled by an electric power source and perform tasks such as mixing, separating, or transferring materials. The term may also accurately be used to describe equipment commonly used in other industries; for example, residential machines such as dish washers and refrigerators, manufacturing machines such as lathes and CNC cutting equipment, and commercial machines such as vending and electronic banking systems.

As mentioned above, OPC is a standards specification created to communicate real-time data between devices from different manufacturers. In the present state of the art, OPC servers, particularly in machine monitoring, do not have the ability to automatically recognize which device is being connected. In most industries, once an OPC server is configured for a particular device, the device remains stationary and, if replaced, it must be replaced with the same or similar device that has the same configuration so as to communicate with the preconfigured OPC server. In industries that require machines to be swapped and rotated from one location to the next, it would be advantageous to have an OPC server with the ability to automatically recognize and connect to remote machines or client devices in real-time regardless of their configuration or type.

As used herein, “real-time” may be used to describe a process that generates output at a rate equal to or greater than the rate in which input information is provided. “Real-time” processes are completed within the minimum amount time required to collect, transfer, process, and output information without any additional time taken to perform non-essential tasks such as intermediate data storage. For example, in some embodiments, a process that occurs in real-time may occur between 0.01 seconds and 10 minutes, and more preferably between 0.5 seconds and 30 seconds. In one embodiment, a programmable logic controller may generate output at a rate of one data point per second and “real-time” data is extracted from the controller and transferred to a computing device at a rate of one data point per second. Other common examples of “real-time” data may include stock market quotes and current weather information.

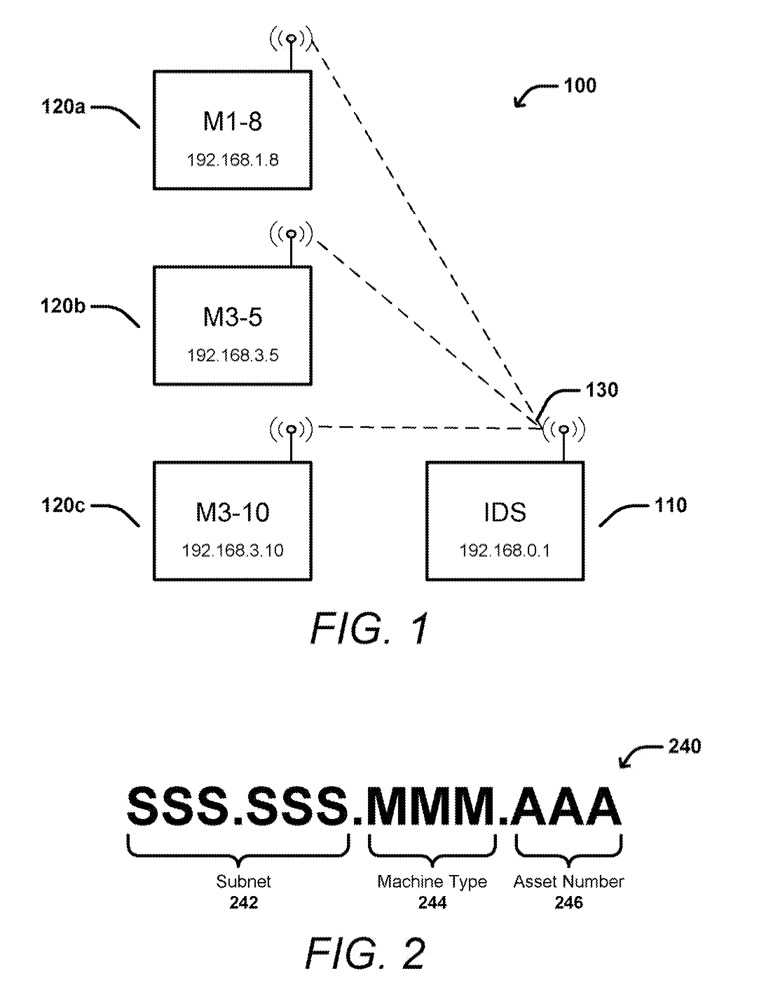

FIG. 1 illustrates an exemplary remote monitoring system 100, wherein an IDS 110 having an OPC server (not shown) therein, is in communication with a plurality of remote machines 120a-c, each remote machine having a programmable logic controller (PLC) (not shown), wherein the PLC controls the remote machines via wireless signal 130. In some embodiments, the PLC has a unique network identifier (not shown) assigned thereon and which is based on a function of the PLC, a manufacturer of the PLC, and/or an asset number. As shown, the IDS 110 is wirelessly connected to three remote machines 120a-c, it is contemplated herein that the IDS 110 may connect to any number of machines within a desired proximity. For example, an IDS may be configured to connect to one machine whereas in additional embodiments the IDS system may be configured to connect to hundreds of machines, or more.

The disclosed IDS may be implemented using a computer or other computing device such as a tablet, phone, and/or laptop, wherein the computer or other computing device may be any type or kind, and wherein the computer or other computing device has a user interface, at least one software module, a wired or wireless network device, at least one antenna, a power supply, and at least one of either a serial radio or an Ethernet radio. As used herein, the term “module” may be used to refer to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

As contemplated herein, the user interface may include at least one of a touchscreen, visual display, keyboard, mouse, pointing device, or any user interface device, or combination of interface devices, commonly used to interact with a computer or a similar electronic medium or any other computing device.

A plurality of software modules may be loaded or installed onto the computer or other computing device in order to aid monitoring and data acquisition from remote machines and devices. For example, the computer or other computing device may include a graphical user interface, allowing the user to interact with a remote machine through the computer or other computing device, thereby monitoring the performance of the remote machine or target device and allowing user input. A graphical user interface is defined as a software platform designed with visual components such as icons, windows, and menus that allow the end user to easily navigate and interact with input and output requirements.

Further, the OPC server may be used to translate the data received from the PLC of at least one remote machine. The OPC server has the ability to translate data from a variety of PLCs and machine or target device manufacturers. The OPC server may be installed on the IDS with the OPC server, it may be part of the OPC server, it may be installed at a remote location, it may be installed on the at least one remote machine, and/or it may be installed on the computer or other computing device. Also, the received data is transferred to an OPC client, allowing for client device and/or remote machine monitoring and user input. The user has the ability to interact with the OPC server via the graphical user interface. The OPC server may automatically detect certain machines or devices within the same network, and connect to the detected machines or devices regardless of the remote machine's or device's PLC type or manufacturer.

Additionally, relational database management system (RDBMS) may be loaded or installed on the computer or other computing device or in any other location in order to store information received from the machines. In such embodiments, when data is received from the remote machine through the PLC, the received data is stored within the RDBMS.

Software modules may be loaded or installed onto the computer or other computing device or in any other location to generate reports. In such embodiments, each report may be automatically generated based on defined user settings, database settings, and report templates.

One or more drivers may be loaded or installed onto the computer or other computing device. For example, it is contemplated herein that the computer or other computing device may include drivers for user input devices and global positioning system (GPS) drivers. In one embodiment, it is contemplated that a driver may be either software and/or hardware that may be used to control the interface between the computer or other computing device and a peripheral device. In some embodiments, the peripheral device may be a keyboard, a mouse, or other third party device that communicates with the computer or other computing device.

The IDS may be equipped with wireless capabilities. It is contemplated herein that the wireless connectivity between the IDS and remote machines or client devices may be facilitated using one or more wireless protocols, such as: cellular radio, Wi-Fi, Bluetooth, WiMax, satellite facilitated communications, or any other wireless communication protocol routinely used in the art.

The IDS may use at least one antenna to further facilitate the communication between devices. For example, the system may include an omnidirectional antenna located within the IDS, the omnidirectional antenna containing one or more separate antennas. In one embodiment, the omnidirectional antenna located within the IDS may contain a total of five separate antennas: two Wi-Fi antennas, two cellular antennas, and one GPS antenna. In additional embodiments other configurations may be used having varying configurations to support each or any of the wireless protocols contemplated herein, so long as the antenna is configured to receive wireless inputs from the remote machines or client devices.

As shown in FIG. 1, each remote machine 120a-c may be equipped with a PLC (not shown) in communication with the IDS using a wired or wireless networking device. As used herein, a wired or wireless networking device may be, for example, a router, switch, or other device which emits a wired or wireless signal and which may allow or otherwise provide the remote machine to have wired and/or wireless connectivity. The networking device may be preinstalled onto the remote machine and may have a known and specific network device identifier, such as an internet protocol (IP) address, media access control (MAC) address, or serial number which can be referenced against a predefined scheme or electronic inventory used to determine the machines type, manufacturer, model, or function. Each networking device and remote machine may have the same or different specific subnet, independent of the function and manufacturer of the connected remote machine or target device.

Illustrated in FIG. 2, is an exemplary embodiment of a network device identification format. Procedures described herein may use a static IP address scheme 240 which allows for connectivity to a near unlimited number of machines. The IP address scheme 240 depicted allows for a subnet identification number 242 possible of two 3-digit integers, a machine-type identification number 244 having a possible 3-digit integer, and an asset identification number 246 having a possible 3-digit integer. Based on the IP address, a router within the IDS is able to automatically connect to the network devices within the machine and prepare for user input and monitoring. When connected, the OPC server in the IDS allows for the translation of data from the machine PLC, wherein the machine PLC is remotely located from the OPC server. It is also contemplated that additional IP address schemes may be employed within the disclosed remote monitoring system.

Before deployment, the OPC server may be preconfigured. Further, there may be an OPC configuration template that may need to be created having at least one channel identification which refers to the machine type and a device identification number which refers to the asset number of the machine or target device. As used herein, the OPC configuration template may refer to a set of predefined OPC server operating settings that are stored in an electronic file format and configured for a specific purpose, wherein the machine types and manufacturers are defined by the network device identifier scheme. For example, in some embodiments, the OPC configuration template may be an extensible markup language (XML) file.

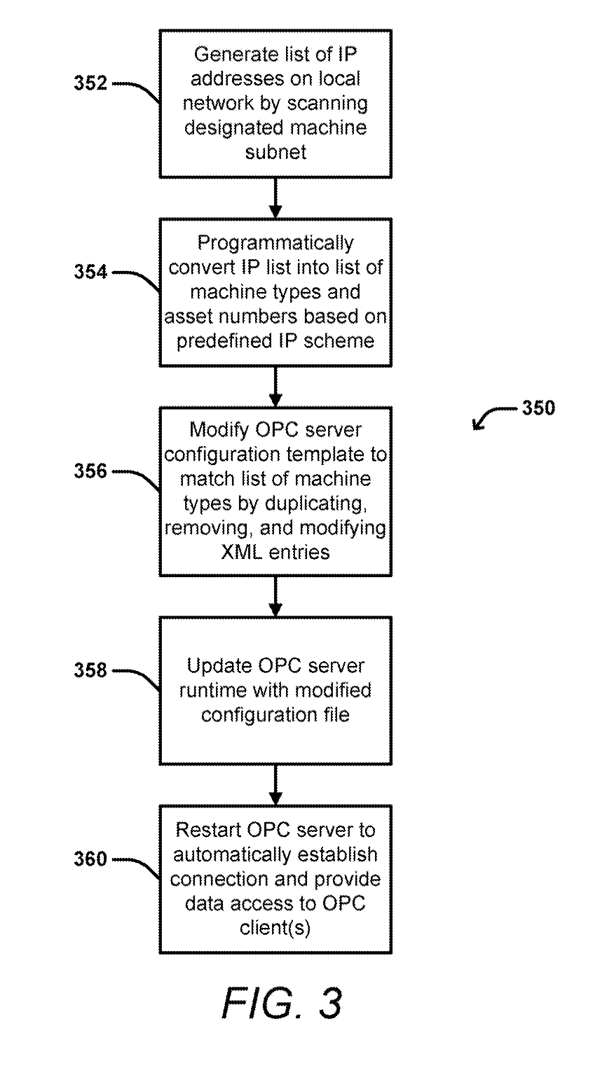

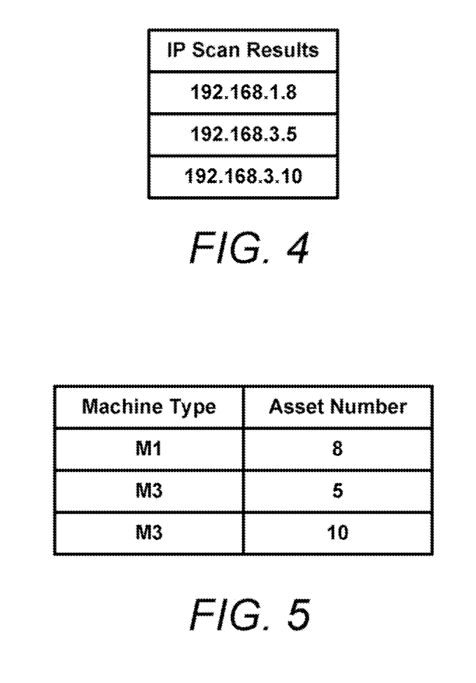

FIG. 3 provides a block diagram describing the process 350 for automatically connecting the OPC server of the IDS to each remote machine. The first step 352 includes scanning a designated network subnet and generating a list of IP addresses on a local network, as shown in FIG. 4. In step 354, the generated IP list is programmatically converted into a list of machine types and asset numbers, based on the predefined IP scheme, as shown in FIG. 5. In step 356, the OPC configuration template is modified to match the list of machine types by duplicating, removing, and modifying XML entries. In step 358, the OPC server runtime is updated with the modified configuration file. In step 360, the OPC server is restarted and automatically establishes a connection and provides data access to OPC client(s).

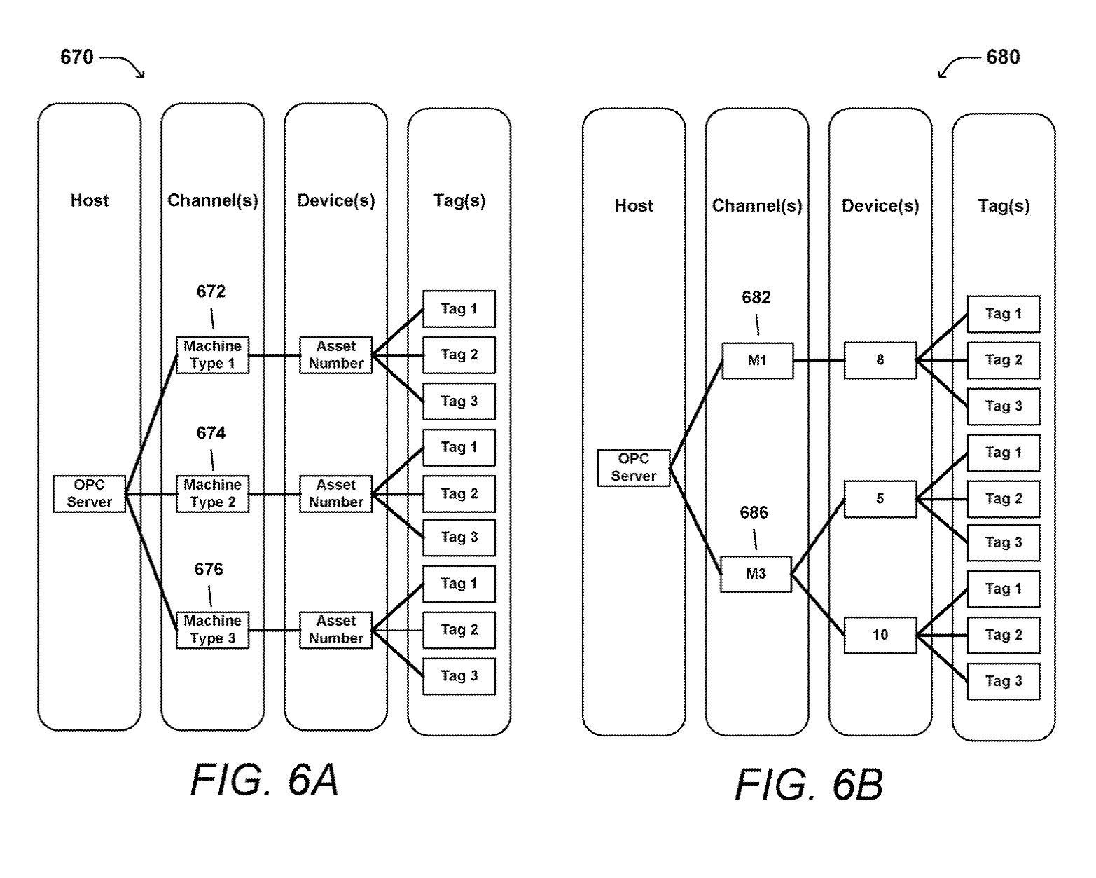

FIGS. 6A and 6B illustrate how the configuration template may be modified. The OPC configuration template 670 is opened and scanned, searching for active machines within each of many channels that may exist. If an active machine is found within a specific channel 672 and 676, the entry is modified to include the machine or target device within said channel 682 and 686. If no active machine is found, the channel 674 is removed from the configuration template. Finally, the modified OPC configuration template 680 is saved within the computer. After modifying the template to reflect the active machines, the OPC Server may then be updated with a new modified OPC configuration template, for example the OPC Server may be shut down and updated. When updated, the new modified OPC configuration template automatically connects to the active machines as dictated by the modified template.

As used herein, the channel or OPC channel represents a communication platform between the IDS machine. In some embodiments, this communication platform consists of a manufacturer-specific driver and a set of communication parameters that may be commonly shared by similar machines. An OPC device may represent a programmable logic controller or any other type of hardware that an OPC server can communicate with. In some embodiments, all devices must be contained within a channel but each channel may contain multiple similar devices. As used herein, an OPC tag may be used to refer to any data input or output address within a programmable logic controller or other hardware device. In exemplary embodiments, all tags must be a contained within a device but each device may contain multiple tags.

In an exemplary embodiment, an IDS comprises a custom enclosure, computer, touch screen, cellular router, power supply, serial and Ethernet radios, cellular antenna, and numerous software modules. A plurality of remote machines are controlled and operated by a PLC, wherein the plurality of remote machines are one of an Ethernet radio, a serial radio, or a combination thereof, and are connected to the PLC. Serial Ports, such as an RS232 port, or Ethernet ports allow for the input and output between the respective radio and the PLC. The antenna within the IDS receives wireless inputs from said radio, processes the data, and allows for easy monitoring of each machine. The omnidirectional antenna located within the IDS contains a total of five separate antennas: two Wi-Fi antennas, two cellular antennas, and one GPS antenna. Power is received from a 12-volt DC power supply located within the IDS enclosure. Wireless sensors, or nodes, can be installed within the IDS to receive inputs and collect further data. External sensors, or nodes, are connected with the IDS wirelessly and are used to transfer outputted data directly to the cellular router within the IDS.

In at least one embodiment, a global server may be used to extract information from a local database and then store the extracted information within the global server. This global server capability allows any user to extract information from any connected machine.

According to any of claims 1-14, embodiments of the integrated data system may include a computer having at least one user interface, at least one software module, a networking module, at least one wired or wireless networking device, and at least one client device. In such embodiments, each of the at least one client devices are in communication with and controlled by the computer. Further, the at least one software module includes instructions that are read by the computer and cause the integrated data system to automatically identify and automatically connect to at least one machine using the at least one wired or wireless networking devices.

According to any of claims 15-18, It is also contemplated that embodiments may include a method for automatically connecting an integrated data system with at least one remote machine, wherein the method includes scanning a network remote machine subnet, wherein the remote machine subnet has at least one remote machine, generating a first list of unique network identifiers, and programmatically converting the first list of unique network identifiers into a second list, wherein the second list has at least one machine type and at least one asset number. Further according to any of claims 15-18, It is also contemplated that embodiments may include, modifying at least one object linking and embedding for process control server configuration template to form at least one modified object linking and embedding for process control server configuration template, wherein the modified object linking and embedding for process control server configuration template is compatible with the second list, and wherein the at least one object linking and embedding for process control server configuration template is stored within at least one integrated data system. Further according to any of claims 15-18, It is also contemplated that embodiments may include, updating at least one object linking and embedding for process control server runtime with the modified object linking and embedding for process control server configuration template to form at least one updated configuration template, establishing a connection automatically between the integrated data system and restarting the at least one integrated data system to automatically establish a connection with the at least one remote machine. In such embodiments, the remote machine subnet comprises at least one remote machine; the modified configuration template matches the second list; and the at least one object linking and embedding for process control server configuration template is stored within at least one integrated data system.

According to claims 19-21, embodiments may include a non-transitory computer readable medium having stored thereon, at least one software module, wherein the at least one software module has at least one code section that is executable by an integrated data system to perform a method, wherein the method includes, scanning at least one remote machine subnet, wherein the at least one remote machine subnet comprises at least one remote machine, generating a first list comprising a plurality of unique network identifiers, programmatically converting the first list into a second list, wherein the second list comprises a plurality of machine types and asset numbers, modifying at least one object linking and embedding for process control server configuration template to be compatible with the second list, wherein the at least one object linking and embedding for process control server configuration template is stored within an integrated data system, updating the object linking and embedding for process control server configuration template to create an updated configuration template, and restarting the object linking and embedding for process control server configuration template to automatically establish a connection with the at least one remote machine based on the updated configuration template.

Described herein are preferred aspects of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An integrated data system, comprising:
a computer having at least one user interface;
at least one software module;
a networking module;
at least one wired or wireless networking device; and
at least one client device, wherein the at least one client device is in communication with and controlled by the computer, and
wherein the at least one software module includes instructions that are read by the computer and cause the integrated data system to automatically identify and automatically connect to at least one machine using the at least one wired or wireless networking devices.

2. The integrated data system of claim 1, wherein the at least one user interface further comprises at least one touchscreen.

3. The integrated data system of claim 1, wherein the at least one wired or wireless networking device is at least one omnidirectional antenna containing at least one antennae therein.

4. The integrated data system of claim 1, wherein the at least one client device is one of an Ethernet radio, a serial radio, and a combination of the two.

5. The integrated data system of claim 1, wherein at least one programmable logic controller controls the at least one machine.

6. The integrated data system of claim 5, wherein the programmable logic controller has a unique network identifier assigned thereon.

7. The integrated data system of claim 6, wherein the unique network identifier is comprised of at least one of a function of the programmable logic controller, a manufacturer of the programmable logic controller, and an asset number.

8. The integrated data system of claim 1, wherein the integrated data system automatically scans and detects one or more remote machines having one or more unique network identifiers thereon.

9. The integrated data system of claim 8, wherein the one or more remote machines are located within a predetermined proximity from the integrated data system.

10. The integrated data system of claim 7, wherein the integrated data system automatically identifies each of the one or more unique network identifiers on the at least one programmable logic controllers.

11. The integrated data system of claim 1, wherein the at least one software module is an object linking and embedding for process control server.

12. The integrated data system of claim 11, wherein the object linking and embedding for process control server further comprises a server configuration template.

13. The integrated data system of claim 12, wherein the server configuration template is updated based on the at least one unique network identifiers of the at least one machine.

14. The integrated data system of claim 13, wherein the server configuration template is implemented by the object linking and embedding for process control server upon restart of the integrated data system.

15. A method for automatically connecting an integrated data system with at least one remote machine comprising:
scanning a remote machine subnet, wherein the remote machine subnet comprises at least one remote machine;
generating a first list of network identifiers;
programmatically converting the first list of network identifiers into a second list, wherein the second list comprises at least one machine type and at least one asset number;
modifying at least one object linking and embedding for process control server configuration template to form at least one modified object linking and embedding for process control server configuration template, wherein the modified object linking and embedding for process control server configuration template is compatible with the second list, and wherein the at least one object linking and embedding for process control server configuration template is stored within at least one integrated data system;
updating at least one object linking and embedding for process control server runtime with the modified object linking and embedding for process control server configuration template to form at least one updated configuration template;
establishing a connection automatically between the integrated data system and
restarting the at least one integrated data system to automatically establish a connection with the at least one remote machine.

16. The method of claim 15, further comprising providing data access to at least one object linking and embedding for process control server client.

17. The method of claim 15, wherein the programmatically converting is based on a predefined network identifier scheme, reference to a relational database, or both.

18. The method of claim 15, wherein the restarting is based on the at least one updated configuration template.

19. A non-transitory computer readable medium having stored thereon, at least one software module, wherein the at least one software module has at least one code section that is executable by an integrated data system to perform a method, wherein the method comprises:
scanning at least one remote machine subnet, wherein the at least one remote machine subnet comprises at least one remote machine;
generating a first list comprising a plurality of unique network identifiers;
programmatically converting the first list into a second list, wherein the second list comprises a plurality of machine types and asset numbers;
modifying at least one object linking and embedding for process control server configuration template to be compatible with the second list, wherein the at least one object linking and embedding for process control server configuration template is stored within an integrated data system;
updating the object linking and embedding for process control server configuration template to create an updated configuration template; and
restarting the object linking and embedding for process control server configuration template to automatically establish a connection with the at least one remote machine based on the updated configuration template.

20. The non-transitory computer readable medium of claim 19, further comprising providing data access to at least one object linking and embedding for process control server client.

21. The non-transitory computer readable medium of claim 19, wherein the programmatically converting is based on a predefined network identifier scheme or reference to a relational database.
